(19) United States
(12) Patent Application Publication
(10) Pub. No.: US 2007/0261708 A1
(43) Pub. Date: Nov. 15, 2007

(54) Retaining Device for Hair Ornament, Wig Provided with the Same, Method of Wearing the Wig, and Squashing Tool for Wearing the Same

(75) Inventors: Masahiro Makino, Tokyo (JP); Mayumi Toba, Tokyo (JP); Sanae Sakuma, Tokyo (JP); Yoshimi Sasaki, Tokyo (JP); Akemi Sato, Tokyo (JP); Satsuki Koyanagi, Tokyo (JP); Mutsumi Kawasaki, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ADERANS CO., LTD., Tokyo (JP)

(21) Appl. No.: 11/661,262

(22) PCT Filed: Jul. 6, 2005
(86) PCT No.: PCT/JP05/12487

§ 371 Date: Feb. 27, 2007

(30) Foreign Application Priority Data
Aug. 30, 2004 (JP) 2004-251082
Sep. 3, 2004 (JP) 2004-257309

(51) Int. Cl. A41G 3/00; A41G 5/00; B25B 7/02

(52) U.S. Cl. 132/201; 132/53; 81/418

(57) ABSTRACT

A method of retaining a hair ornament such as a wig to hair comprises the steps of fixing retaining devices for hair ornament (10) to the hair ornament, wherein the retaining device for hair ornament (10) has a squashable tube (11) into which a plurality of hairs are to be inserted, and a net (13) attached with an adhesive tape (12) having adhesive layers (12b, 22b) on the inner surface of said tube (11), inserting a plurality of hairs (101) into the tube (11), and squashing the retaining device for hair ornament (10). Thereby, since the retaining device for hair ornament (10) is tightened to hair (101), as well as the hair (101) is adhered to the net (13) with the adhesive permeated through the mesh of the net (13), so that the hair ornament can be easily and firmly retained on to the hair, and does not easily slip off from the hair.

### TECHNICAL FIELD

This invention relates to a retaining device for hair ornament to retain such a hair ornament as a hair accessory and a wig on human or artificial hair, a wig provided with said retaining device for hair ornament, and a method of wearing the wig, and further to a squashing tool used for wearing the wig with said retaining device for hair ornament.

### BACKGROUND ART

So far, in order to wear such a hair ornament as a wig on a head, such a method, for example, is known as fixing a hairpin or a stopper for hair made from a hairpin to a hair ornament, and inserting the pin portion of said stopper for hair into hair to clip the hair. Such methods are also known as adhering a hair ornament to hair by using an adhesive, and fixing a hair ornament by knotting it to hair using a knotting part such as thread.

In addition, for example, Reference 1 (the Japan laid open application H05-321009, 1993) discloses a method by which a portion of a wearer's own natural hair is taken with a hook needle, inserted into a converging device made of elastic and self-lubrication rubber or plastics, and further into said converging device is inserted a base portion of hair extender, thereby the hair extender is attached. Reference 2 (the Japan Utility Model laid open application H07-28924, 1995) discloses a tool to pull out the parent hair which is so designed not to damage a net or a base sheet of a hair piece when the hair piece is worn on to the parent hair. In Reference 3 (the Japan laid open application H10-60721, 1998), it is also disclosed that said converging device disclosed in Reference 1 has a double layer structure with a hard member as the outer layer, and an elastic synthetic resin sheet such as rubber, urethane resin, and others as the inner layer, and is attached to hair by pressing the converging device with the hair inserted into said retaining device. Said converging device is made of a metallic tube of aluminum, cupper, or the like of about 3-4 mm length and about 2-3 mm inner diameter (outer diameter of about 3-4 mm), so that it can be easily and surely squashed. In case that said metallic tube is fixed on the inner periphery of a wig, a plurality of hairs are, for example, inserted into said tube, and the tube is squashed, the whole aluminum tube is squashed using such squashing tools as commercial pliers.

If a hair ornament is that which has various decorations such as additional hair of so-called extension, animals, plants, and character goods, then it is no trouble for outlook appearance if a retaining device to fix it to hair is found out. However, in case of a retaining device for a wig, since said retaining device has to be hidden under the wig so not to be found out, its size and diameter have to be made as small as possible, but the retaining device of hairpin shape has a limit in size and diameter, and is not preferable since the wig floats up if it is provided at the positions along hairline.

When a wig is held by using the retaining device disclosed in the above-mentioned Reference 1 or 3 and inserting hair into a tube, it is worn on to the wearer's own natural hair by pushing in a large quantity of hairs into the hollow portion of the tube and by the squashing force applied to said retaining device, so that the frictional binding force between the tube and hair is weak, and the retaining device tends to slip off from the hair.

Here, commercial pliers are used to squash said retaining device with hair inserted therein, and, though the pinching portion of commercial pliers have the breadth in the perpendicular direction to the axis gradually narrowed to the tip, the narrowest portion at the tip has the breadth of 4 mm or more. Therefore, commercial pliers would squash the whole length of an aluminum tube as quite short as about 3-5 mm like the above-mentioned retaining device for hair ornament. If the whole retaining device for hair ornament is squashed and fixed to hair, it is quite problematical as it is necessary to reopen the squashed both ends of the tube with forceps or a hook needle to remove from hair when said retaining device for hair ornament is to be removed from hair after several days. Also, by pressing the whole metallic tube with hair inserted therein, the whole tube is flattened with the pressing force evenly dispersed, and the concave portion made on to the outer side of the tube with the pinching portion of pliers is shallow, resulting in wide gap between a tube and the inserted hair. Thereby, the binding force to the inserted hair is weak, the tube tends to slip off from hair, and the hair near the squashed both ends of the tube tends to be cut off.

### DISCLOSURE OF THE INVENTION

### Problems to be Solved

It is the first object of the present invention, referring to the above-mentioned problems, to provide a retaining device for hair ornament capable of firm and easy retaining of such a hair ornament as a hair accessory and a wig to a wearer's own natural or artificial hair, which would not easily slip off from hair once retained thereon.

The second object of the present invention is to provide a wig provided with said retaining device for hair ornament capable of firm and easy retaining, which would not easily slip off from hair once retained thereon.

The third object of the present invention is to provide a method of wearing the wig provided with said retaining device for hair ornament firmly and well-fitting on to a head.

Further, the fourth object of the present invention is to provide a squashing tool to squash said retaining device for hair ornament with hair inserted therein, which is capable of forming a concave portion in the retaining device for hair ornament narrower than its pinching portion by squashing only a portion of said retaining device for hair ornament when said wig is worn on to a head.

### Means to Solve Problems

In order to achieve said first object, the retaining device for hair ornament of the present invention comprises a tube into which a plurality of hairs are to be inserted, and a net attached on the inner surface of said tube preferably with an adhesive. Since a net is attached inside the tube, hair would not easily slip off from the tube. The retaining device for hair ornament can be firmly retained to hair by squashing and flattening the retaining device for hair ornament, as the lower adhesive layer of the net is deformed, the adhesive permeates out through its mesh, and adheres to hair by entangling with the inserted hair.

Said tube is preferably made of a squashable short tube of a metal such as aluminum, gold, silver, cupper, and cupper-nickel alloy. Said tube is preferably designed as a short diameter and short length tube having a radial thickness of 0.2-0.3 mm, and a length of 2.5-3.5 mm. Said net is attached on the inner surface of the tube by adhering with a double-stick adhesive tape having adhesive layers on both sides. With the net attached inside the tube using an adhesive tape, insertion of hair is easy as the hair and the adhesive layer do not contact directly when the hair is inserted into the tube, and the hair is tightened by moving the retaining device for hair ornament close to the root of hair after insertion, and squashing the tube, as well as hair is adhered to the net at the same time as the adhesive permeates out through its mesh, so that hair does not slip off from the retaining device nor loosen to move, thereby the retaining device for hair ornament can be firmly fixed to hair. Also, using a tube of compact size makes it easy to insert hair and to detach it after use.

The retaining device for wearing a wig of the present invention comprises a body of the retaining device provided with a squashable tube into which a plurality of hairs are to be inserted, and a net attached on the inner surface of the tube, and a fixing member for fixing the body of the retaining device to the inner surface of the wig, and is so made up as to hold the wig on to a head with hair and the body of the retaining device by squashing said tube with a plurality of hairs inserted therein. Since the net is attached inside the body of the retaining device, the contact area of a plurality of hairs inserted into the tube increases, thereby the net brings out the antislippery function. With the body of the retaining device with the net attached inside having said function fixed on the inner surface of the wig with the fixing member, the wig can be firmly held and worn not to easily slip off from a head.

The fixing member preferably comprises a base portion for fixing the body of the retaining device, an adhesive layer on the surface of the base portion, and a string for fixing the body of the retaining device on to the back side of the base portion, and the adhesive layer of the surface of said base portion is fixed by adhesion on to the inner surface of a wig. The base portion of the fixing member may be made of an adhesive tape having an adhesive layer coated on the surface of a core member, thereby the body of the retaining device is fixed on to the core member of the back side of the base portion. The base portion of the fixing member may be made of a double-stick adhesive tape having two adhesive layers coated on the front and the back sides of the core member, wherein the body of the retaining device may be adhered to the adhesive layer on the back side of the base portion. The string may be inserted into the tube of the body of the retaining device, and its both ends are inserted into the base portion and bound, thereby fixing the body of the retaining device to the base portion.

When the retaining device of the present invention is used for a wig, a net inside the squashed tube firmly holds hair by frictional binding, and hair and the net, as well as hairs mutually, are adhered with an adhesive, thereby the wig does not move or fall off. Therefore, by providing a plurality of said retaining device for wearing a wig on the periphery of its inner side, the hair inserted into the body of the retaining device can be firmly retained, no moving nor fall off occurs, thereby the wig can be stably worn.

In order to achieve said second object, a wig provided with retaining devices for hair ornament of the present invention comprises a body of the wig, and a plurality of retaining devices for hair ornament fixed on the periphery of the inner surface of said body of the wig, wherein the retaining device for hair ornament includes a squashable tube into which a plurality of hairs are to be inserted, a net attached on the inner surface of said tube, and an adhesive tape provided between said net and the inner wall of the tube to adhere the net to the tube. Preferably, the retaining device for hair ornament is fixed to the inner periphery of the body of the wig so that the axis of the tube is aligned perpendicular to the periphery of the body of the wig. In the wig of the present invention, each retaining device for hair ornament provided on the periphery of the inner side of the body of the wig has a net attached inside, and said net brings out antislippery function, so it does not easily slip off from the inserted hair. Therefore, as a result, the wig is not easily detached from a head, held firmly, thereby the fit feeling is improved. If the retaining device for hair ornament is fixed perpendicular to the periphery of the body of the wig, the hairs around the retaining device for hair ornament along the hairline can be easily inserted into the tube.

In order to achieve said third object, a method of wearing a wig comprises the steps of fixing a plurality of retaining devices for hair ornament on the periphery of the body of the wig at proper intervals, wherein the retaining device for hair ornament has a squashable tube into which a plurality of hairs are to be inserted, and a net attached on the inner surface of said tube with an adhesive tape having an adhesive layer, inserting a plurality of hairs into said tube with said body of the wig placed on a wearer's head, moving said retaining device for hair ornament close to the head skin, tightening the retaining device for hair ornament to the hair by squashing said tube, and adhering the hair to the net with the adhesive permeated out through the mesh of the net, wherein insertion of hair into said tube, moving the retaining device for hair ornament close to the head skin, and squashing are carried out in turn, thereby the wig is worn on to the head by fixing a plurality of retaining devices for hair ornament to the hair. Each retaining device for hair ornament provided on the periphery of the inner side of the body of the wig has a net attached inside, and said net brings out antislippery function, so it does not easily slip off from the inserted hair. Therefore, said retaining device for hair ornament does not easily slip off from hair, and hence the wig can be made not to come off easily from a head. Also, the wig can be worn on to a head easily in short time only by inserting hair into and squashing each retaining device for hair ornament.

Since the net is attached inside with a double-stick adhesive tape to the retaining device for hair ornament, hair and the adhesive layer of the double-stick adhesive tape do not contact directly when the hair is inserted into the tube, and hence the insertion of hair is easy. After the insertion of hair, since the hair is tightened by moving the retaining device for hair ornament close to the root of hair and squashing the tube, at the same time the adhesive permeates through mesh of the net to adhere the hair with the net, the hair does not move by loosening or slipping off from the retaining device, and the retaining device for hair ornament can be firmly fixed to hair. By using a tube of compact size, hair is easily inserted, as well as is easily detached after use. While the wig is worn, each retaining device for hair ornament fixed on the periphery of the inner side of the body of the wig does not easily slip off from hair, thereby the wig does not easily move or slip off, and stable and good fit feeling can be attained.

In order to achieve the fourth object, the present invention is a squashing tool, having a pair of levers axially supported rotatably around an axial portion, and two pinching portions formed to tip end sides from the axial portion of said levers for squashing a retaining device for hair ornament, wherein a convex portion is formed along the length direction in the pinching portion formed in one of the levers, and a linear or a narrow band-like concave portion corresponding to said convex portion is formed on the retaining device for hair ornament by pinching the retaining device for hair ornament with two pinching portions, that is, by squashing with a pre-set pinching pressure.

Upon pinching the retaining device for hair ornament with two pinching portions by grabbing the rear end sides of a pair of levers of said squashing tool, since the convex portion formed at one of pinching portions squashes the retaining device for hair ornament, and forms a linear or narrow band-like concave portion on a portion of the retaining device for hair ornament, the both ends or one end of the retaining device for hair ornament is not completely squashed, and only a portion of the retaining device for hair ornament can be firmly squashed. In case that the retaining device for hair ornament is compressed, by inserting soft hair into a tube of the retaining device, and squashing with the convex portion of the squashing tool a portion of the periphery of the tube, for example, its central portion, local squashing force is applied to the convex portion. With the convex portion formed along the length direction of one of the pinching portions and a groove formed in the direction crossing said convex portion, since the concave portion formed on the periphery of the tube is made deeper, the gap between the inside of the tube and hair inserted therein is made narrower, and the tightening force to the inserted hair is strong, thereby the retaining device retained to hair is made to tend less to slip off from hair, as well as both ends of the tube are not strongly squashed, so the hair close to both ends of the tube is not easily cut off. Since both end portions of the tube is not strongly squashed, upon detaching the retaining device for hair ornament from a head, a detaching tool such as forceps and a hook needle can be easily inserted into both end portions of the tube, thereby detaching is conducted with ease. By properly adjusting the sizes of height and width of the convex portion formed in one of the pinching portions, the depth and width of squashing of the retaining device for hair ornament can be properly designed.

Preferably, in the pinching portion formed in one of the levers among said pair, one or more of grooves for antislippage are formed in a crossing direction to said convex portion. Thereby, upon retaining and pressing the retaining device for hair ornament, said retaining device for hair ornament does not slip, and a concave portion is firmly formed in said retaining device for hair ornament. One or more of said convex portions are formed. By properly forming one or more of convex portions, concave portions can be formed depending upon the size of the retaining device for hair ornament, or in desired numbers at desired positions, and any squashing tool can be used depending upon its way of use. Said convex portion may be formed along the length direction of each lever at a pair of pinching portions of the levers, and either at a corresponding identical position of each lever, or at a different position.

Further, by the squashing tool of the present invention, the retaining device for hair ornament can be squashed with one or a pair of convex portions of pinching portions of the squashing tool, and a linear or narrow band-like concave portion can be formed thereon, hence only a portion, or more typically at the central portion of a tube, can be firmly squashed. By properly adjusting the size of width of the convex portion formed in the pinching portion, a concave portion smaller than the width of the pinching portion of the squashing tool can be formed. Therefore, by squashing the tube of the retaining device for hair ornament with the convex portion of a squashing tool, a gap is not formed between the tube and hair inserted therein at the central portion of the squashed tube, hence the retaining device for hair ornament does not easily slip off from hair. Also, since both end portions of a tube have a little opening shape because of not strong squashing, a detaching tool such as forceps and a hook needle can be easily inserted into the tube upon detaching the retaining device for hair ornament from hair, and hence the inner periphery of the tube can be easily opened. Therefore, detaching of said retaining device for hair ornament can be easily and quickly conducted.

### BRIEF DESCRIPTION OF THE DRAWINGS

FIG. 1 is a schematic view illustrating an example of a retaining device for hair ornament in accordance with the present invention, and (A) is a side view, and (B) is a cross-sectional view along the line A-A.

FIG. 2 is a diagonal view illustrating an example of embodiment of the retaining device for hair ornament in accordance with the present invention.

FIG. 3 is a schematic view illustrating a retaining device for wearing a wig in accordance with the present invention, and (A) is a diagonal view, and (B) is a cross-sectional view along the line B-B.

FIG. 4 is a schematic view illustrating an example of a wig provided with the retaining device for hair ornament in accordance with the present invention.

FIG. 5 is a diagonal view illustrating a peripheral frame member and its vicinity as a base outer periphery of FIG. 4.

FIG. 6 is a cross-sectional view along the line C-C of FIG. 5.

FIG. 7 is a diagonal view illustrating a part of the wig provided with a retaining device for hair ornament in another embodiment different from FIG. 4.

FIG. 8 is a schematic view illustrating a method of wearing the wig provided with the retaining device for hair ornament of FIG. 4, and (A) is the step to insert a wearer's own natural hair into the hollow portion of the retaining device for hair ornament, and (B) is the step to squash the retaining device for hair ornament.

FIG. 9 is a schematic view illustrating a squashing tool in accordance with the present invention.

FIG. 10 (A) is a diagonal view illustrating one of the pinching portions of FIG. 9, (B) is a cross-sectional view along the line D-D, (C) is a diagonal view illustrating the other of the pinching portions of FIG. 9, and (D) is a cross-sectional view along the line E-E.

FIG. 11 is a view illustrating each pinching portion contacting upon grabbing the grabbing portions of the squashing tool in accordance with the present invention.

FIG. 12 is a schematic view illustrating the step to squash a tubular retaining device for hair ornament in accordance with the present invention with the squashing tool, and (A)-(C) are side views, (D)-(F) are diagonal views from the tip side of a retaining device for hair ornament, and (G) is a diagonal view of the retaining device for hair ornament after squashed.

FIG. 13(A) is a diagonal view illustrating an example of another embodiment of the squashing tool, and (B) is a view from the arrow mark F of (A).

FIG. 14 is a plan view illustrating a squashed terminal after the tubular portion of a squashed terminal in accordance with the present invention is squashed with the squashing tool.

### EXPLANATION OF MARKS AND SYMBOLS

10, 20 Retaining Device for Hair Ornament
11 Tube
12, 22 Double-Stick Adhesive Tape
12a, 22a Core Member
12b, 12c, 22b, 22c Adhesive Layer
12d, 22d Peeling Paper
13, 32 Net
15, 34 Artificial Hair
16 Concave Portion of Tube
21 Base Portion
23, 43 String
30, 40 Wig Provided with Retaining Device for Hair Ornament
31 Body of Wig
33 Peripheral Frame Member
100 Head
101 Natural Hair
110 Squashing Tool
111 Axial Portion
115a, 115b Pinching Portion
116, 117 Pinching Face
116a Convex Portion
116b Cutting Face
118 Groove

### BEST MODES FOR CARRYING OUT THE INVENTION

The present invention will better be understood from the following detailed description and the drawings attached hereto showing certain illustrative forms of embodiment of the present invention. In this connection, it should be noted that such forms of embodiment illustrated in the accompanying drawings hereof are intended in no way to limit the present invention but to facilitate an explanation and an understanding thereof. In each figure, identical marks and symbols are used for identical or corresponding parts and members.

(1) Structure of a Retaining Device for Hair Ornament in Accordance with an Embodiment.

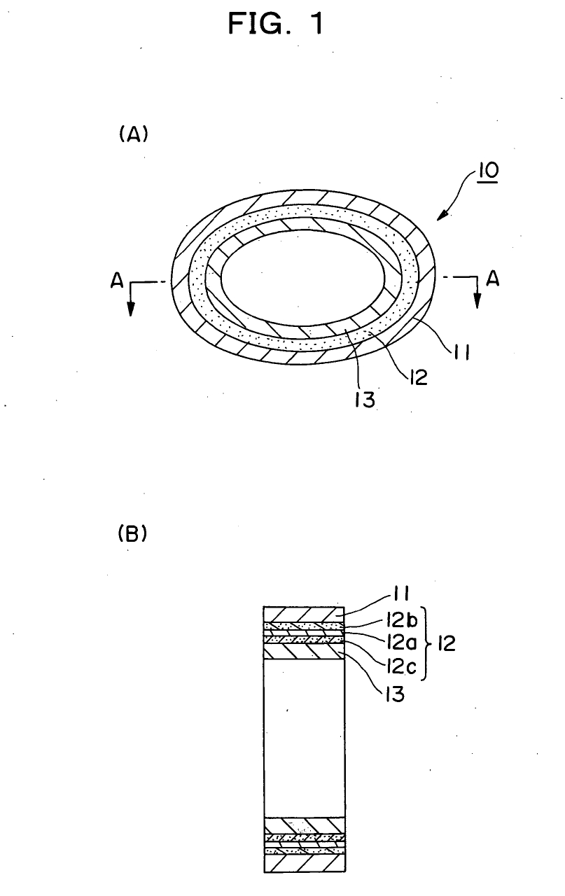

Explanation is first made of a retaining device for hair ornament in accordance with the present invention (to be called merely a retaining device). Here, the retaining device for hair ornament means the retaining device for hair ornament for attaching and retaining such a hair ornament as a wig and a hair accessory to the hair of a head. Said retaining device comprises, for example, a tube into which a plurality of hairs are to be inserted, and a net attached on the inner surface of said tube to attach on to hair. FIG. 1 is a schematic view illustrating an example of said retaining device, and (A) is a side view, and (B) is a cross-sectional view along the line A-A. A retaining device 10 comprises, as shown in FIG. 1, a tube 11, a double-stick adhesive tape 12 as an adhesive to be inserted and adhered to the inner surface of the tube 11, and a net 13 adhered on the (inner) surface of said double-stick adhesive tape 12. The tube 11, the double-stick adhesive tape 12, and the net 13 are all thin, and are illustrated in exaggeration in the figure.

The tube 11 is a squashable short tube made of a metal, such as, for example, aluminum, gold, silver, cupper, cupper-nickel alloy. Its outer surface is colored in such modest color as skin color and gray to reduce glossy metallic color, as well as antireflection is applied. (The painted portion is not shown in the figure.) The cross-sectional shape of the tube 11 may be, as shown in FIG. 1(A), ellipsoidal or circular. Since, after hair is inserted into said tube 11, said tube 11 is compressed and squashed to the extent that the hair is not easily pulled out (this process is called squashing), the tube 11 is preferred to have ellipsoid cross-section taking into consideration the working efficiency. If the tube 11 is made of aluminum or cupper having, for example, a radial thickness of 0.2-0.3 mm, especially around 0.25 mm, an inner diameter of about 2.5-3.5 mm, a length of 2-5 mm, especially about 3 mm, it is preferable for working efficiency, and also with regard to the hair holding. For requirement of inserting and holding a certain quantity of hair in the tube 11, the inner surface area of the tube 11 suffices by about 7 mm². Since a retaining device 10 is squashed with hair inserted therein as described later, the length of the tube 11 suffices by the minimum requirement of length for squashing with a squashing tool, that is, 2-5 mm as mentioned above, especially about 3 mm.

The adhesive may be a known double-stick adhesive tape 12 comprising a core member 12a, adhesive layers 12b and 12c provided on both sides of said core member 12a, and peeling paper 12d peelably adhered on the outer side of the adhesive layer 12c. Although said double-stick adhesive tape 12 is not in direct contact with skin, it is preferably the adhesive tape for medical use, as its adhesive is contacted to hair, and its adhesive is preferably a so-called pressure-sensitive adhesive.

The net 13 may be made either of filaments woven to a certain mesh, or of filaments merely aligned grating-like orthogonally. Here, since an inner diameter of the tube is, as described later, as quite thin as about 2-3 mm, the fiber diameter of filament may be, corresponding thereto, as thin as, for example, 0.03-0.1 mm or so, and made to small mesh of about 50-100 mesh for easy handling.

(2) An Example of Method of Manufacture of the Retaining Device 10

First, the adhesive layer 12c of one side of a double-stick adhesive tape 12 is adhered to the back side of a net 13. Next, into the above-mentioned tube 11, the double-stick adhesive tape 12 made tubular is inserted with the net 13 inside, and the other adhesive layer 12b is contacted on the inner surface of the tube 11, and the other adhesive layer 12b is adhered on the inner surface of the tube 11 by making use of the recovery force to expand of the net 13 and the double-stick adhesive tape 12 made tubular. Through the above-mentioned processes, the retaining device for hair ornament 10 with the net 13 adhered on the inner surface of the tube 11 via an adhesive can be manufactured.

(3) An Example of Embodiment of the Retaining Device for Hair Ornament 10

A retaining device for hair ornament 10 is suitable to firmly fit such a hair ornament as a hair accessory and a wig to a wearer's own natural or artificial hair. Namely, the retaining device for hair ornament 10 can be used for retaining a hair ornament having such decorations as animals, plants, and character goods, and a so-called extension to hair as hair decorations. In this case, by coloring variously the retaining device 10 of the present invention so that excellent decoration like beads appears, the retaining device 10 is also made to constitute a part of a hair ornament. As another embodiment, the retaining device for hair ornament 10 is attached on the inner side of a wig, and can be used as a retaining device to wear the wig. In this case, by inserting hair into the tube 11 of the retaining device 10, and fixing the retaining device close to the root of hair, the retaining device can be satisfactorily hidden inside the wig due to its small size. In either embodiment, by inserting hair into the tube 11 of the retaining device 10 and squashing the tube 11, the tube 11 is retained on hair. The quantity of hair inserted into the tube 11 in case of a wig, though depending on the density of hair, may be about 20-100 hairs. Insertion of too many hairs results in gathering hairs in the area larger than the diameter of the tube 11, and it is difficult to move the retaining device close to the root of hair.

Hereinafter, embodiments are explained.

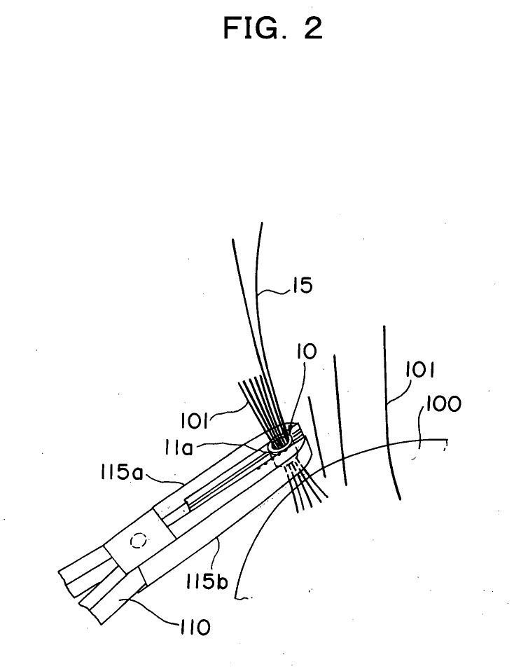

FIG. 2 is a diagonal view illustrating an example of embodiment of a retaining device for hair ornament 10. As shown in FIG. 2, by putting artificial hair 15 of desired color on the outer periphery 11a of the retaining device for hair ornament 10, it may be used as the so-called hair extension. Though only a small part of artificial hair 15 is illustrated in the figure, the artificial hair 15 may be densely planted all over the outer periphery if desired. Instead of artificial hair, such decorations as animals, plants, or character goods may be attached to the retaining device and used as a hair ornament.

First, a part of the natural hairs 101 growing on a head 100 are inserted as a bundle into the tube 11 of said retaining device 10. Since a net 13 is provided on the inner surface of the retaining device 10, natural hair 101 can be easily inserted. Since the adhesive layer 12c of the double-stick adhesive tape 12 is between the outer side of the net 13 and the inner side of the tube 11, an adhesive does not contact to natural hair 101 upon its insertion. Therefore, the adhesive does not adhere to a handler's hand or fingers upon attaching of the retaining device 10, and insertion can be easily handled.

After pulling down the retaining device 10 close to the root of a wearer's own natural hair 101, the retaining device 10 can be attached to the natural hair 101 by squashing the tube 11 with a squashing tool 110 such as pliers. When the retaining device 10 is squashed with a squashing tool 110, the net 13 attached inside the retaining device 10 and a wearer's own natural hair 101 come in tight contact. Therefore, even if the retaining device 10 is pulled from the wearer's own natural hair 101 by applied external force, the natural hair 101 does not easily slip by frictional force with the net 13, and the retaining device 10 does not easily slip off from the natural hair 101. Also, since the adhesive permeates through mesh form the lower adhesive layer 12c of the net 13, and the natural hair 101 inserted into the retaining device 10 and the net 13, and mutual natural hair partially adheres, the retaining device 10 further does not easily slip off from the natural hair 101.

Explanation is next made of an example to use the retaining device for hair ornament in accordance with the present invention for a wig.

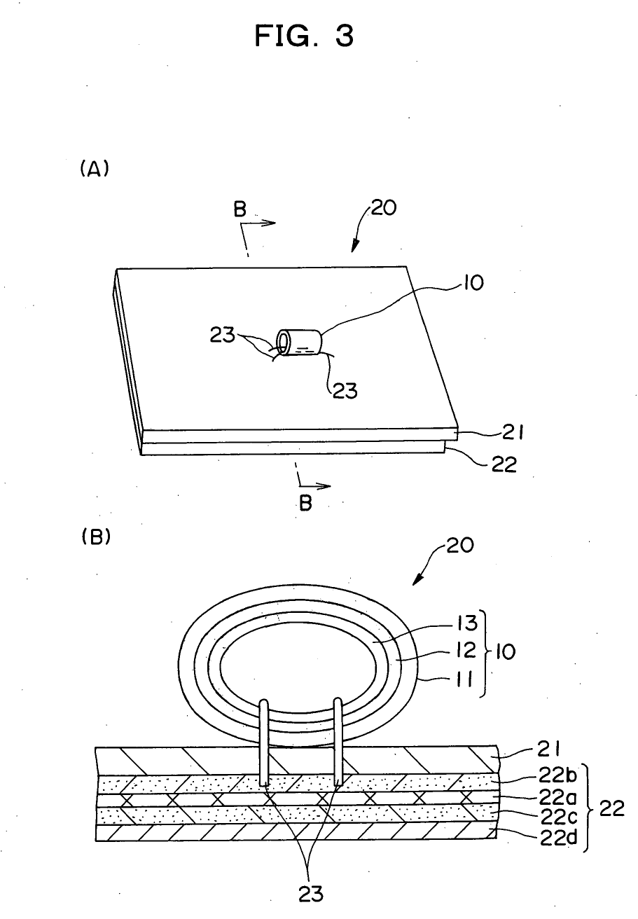

FIG. 3 is a schematic view illustrating a retaining device for wearing a wig 20 in accordance with the present invention, and (A) is a diagonal view, and (B) is a cross-sectional view along the line B-B. The retaining device for hair ornament 10 in accordance with the present invention is provided with a fixing member so that attaching to the body of a wig is easy. Said retaining device provided with the fixing member 10 is hereinafter in some cases called a retaining device for wearing a wig 20. The fixing member is made with a base part 21 fixing the retaining device 10 thereon, and the adhesive tape 22 having an adhesive layer on the outer side attached to its back side. The retaining device 20 is made, as shown in FIGS. 3(A) and (B), by fixing a retaining device for hair ornament 10 to a base part 21 of the fixing member with the string 23, and further attaching the adhesive tape 22 having an adhesive layer to the base part 21 on the side without the retaining device for hair ornament 10 fixed thereon. As the base part 21 of the fixing member, plastic thin sheet such as urethane is preferably used.

Fixing of the retaining device 10 to the base part 21 is by sewing the retaining device 10 on the base part 21 with the string 23, as shown in FIG. 3(B). In this case, the string 23 is inserted into the tube 11, bound to the base part 21, and knotted by binding both ends.

An adhesive tape 22 is preferably a double-stick adhesive tape having adhesive layers 22b and 22c on both sides of a core member 22a. The base part 21 and the core member 22a are adhered with one adhesive layer 22b, while on the other adhesive layer 22c is adhered peeling paper 22d. Instead of the double-stick adhesive layer, a single layer adhesive tape may of course be used. In case that the single layer adhesive tape is fixed to the base part 21 of the retaining device 10, the core member may be adhered to the base part 21 with an adhesive, or the string 23 may be used also to bind the core member to the base part 21. Or the core member of the single layer adhesive tape is used as the base part 21, and the retaining device 10 may be directly set on to said core member, and may be bound with the string 23. In this case, the core member of the adhesive tape should be a tough and more or less hard material. Instead of said single layer adhesive tape, a double-stick adhesive tape may be used. Similarly in this case, a core member of the adhesive tape is made of a tough and more or less hard material as the core member 22a. By directly setting a retaining device for hair ornament 10 on the adhesive layer 22b of one side of the double-stick adhesive tape 22 and binding with the string 23, the retaining device for hair ornament is firmly fixed to a wig owing to adhesion with an adhesive on the tube 11 surface together with binding with the string.

(4) An Example of Structure of a Wig Provided with the Retaining Device

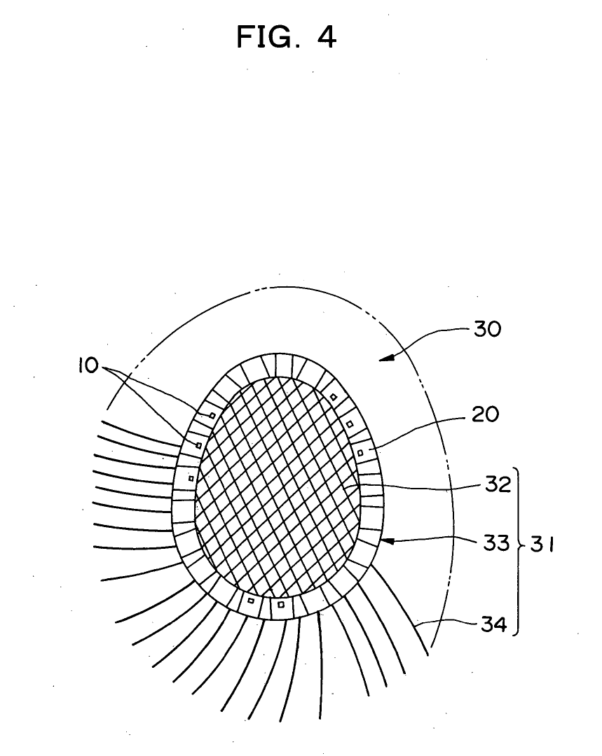

As described above, the retaining device for wearing a wig 20 comprises the body of the retaining device 10 including a squashable tube 11 into which a plurality of hairs are to be inserted and a net 13 attached on the inner surface of said tube 11, and a fixing member for fixing said body of the retaining device 10 on to the inner surface of a wig. A wig 30 can be made using said retaining device for wearing a wig 20, and can be worn on to a head by inserting and holding a plurality of hairs into a tube 10 and with said hairs and said body of the retaining device 10. That is, the wig 30 provided with a retaining device for wearing a wig in accordance with the present invention is, as shown in FIG. 4, to be worn on to a head with the body of the retaining device 10 and hairs. FIG. 4 shows the side of the wig provided with a retaining device for hair ornament 30 to be worn on to a head, namely, the inner side of the body of a wig. The wig provided with the retaining device for hair ornament 30 is such, as shown in FIG. 4, that a plurality of retaining devices for wearing a wig 20 are adhered and fixed on the periphery of the inner side of the body of a wig 31. The body of the wig 31 comprises, for example, a net 32 made of a net sheet, a peripheral frame member 33 as a base periphery to define the shape and size of the body of a wig 31, and many artificial hairs 34 planted on the net 32 and the peripheral frame member 33.

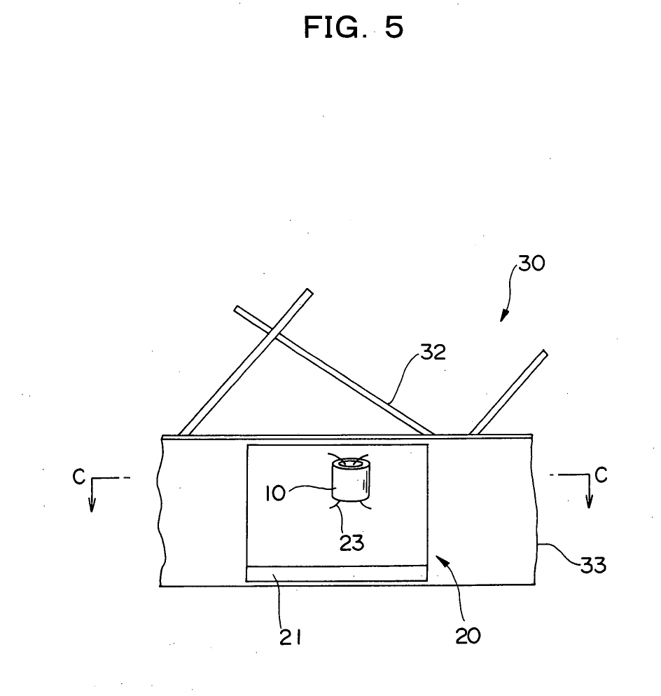

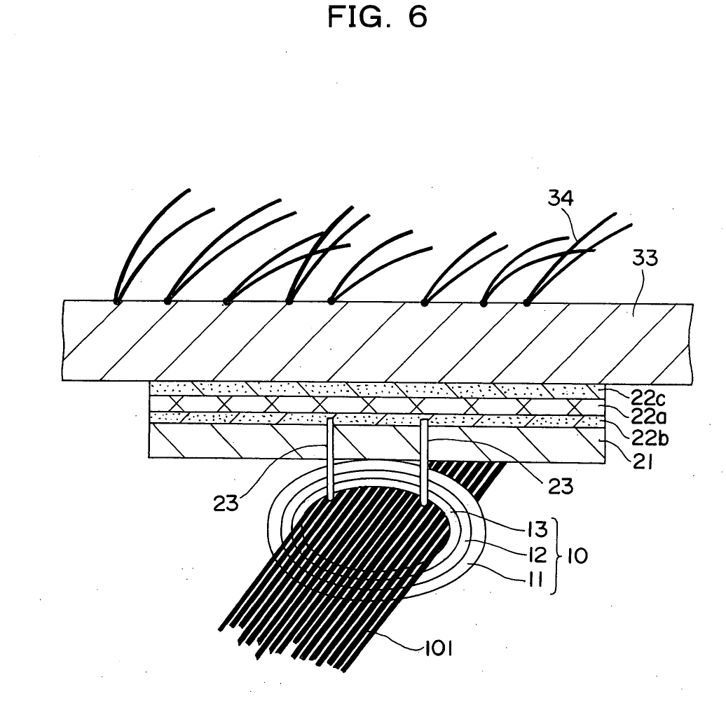

FIG. 5 is a partly enlarged diagonal view illustrating the peripheral frame member 33 of FIG. 4, and FIG. 6 is a cross-sectional view along the line C-C of FIG. 5. As shown in FIG. 5, the retaining device for wearing a wig 20 is adhered to the peripheral frame member 33 via a fixing member so that its axis goes perpendicular to the direction of extension of a peripheral frame member 33, namely, the axis of the tube 11 goes in the direction mutually perpendicular to the direction of extension of a peripheral frame member 33. This is to make it easy to insert the natural hair 101 into a tube 11 by align the axis of a retaining device for hair ornament 10 along its growing direction, as the natural hair 101 grows approximately perpendicular to head skin. Adhesion of the retaining device for wearing a wig 20 to the peripheral frame member 33 may be peeling off the peeling paper 22d from the double-stick adhesive tape 22 as the fixing member of said retaining device 20, and adhering the adhesive layer 22c to the peripheral frame member 33.

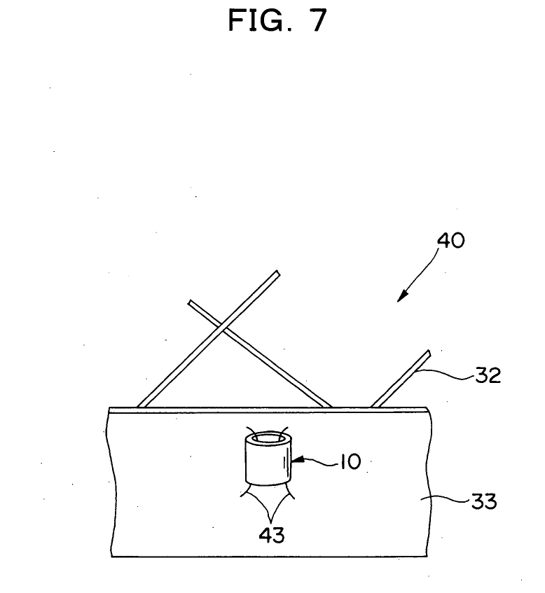

FIG. 7 is a diagonal view illustrating a part of the wig provided with a retaining device for hair ornament 40 in another embodiment different from FIG. 4. The wig provided with a retaining device for hair ornament 40 is such, as shown in FIG. 7, that the retaining device 10 is fixed by directly sewing with the string 43 on a peripheral frame member 33 as an outer periphery of the base. For example, the retaining device for hair ornament 10 is fixed to the peripheral frame member 33 by inserting the string 43 into a tube of the retaining device 10, sewing on the peripheral frame member 33, and by knotting both ends of the string 43. Here, fixing of the retaining device 10 to the peripheral frame member 33 may be by, instead of using the string 43, inserting artificial hair planted on to the body of a wig 31 into the retaining device 10, and binding said artificial hair to other artificial hairs.

(5) A Method of Wearing Wigs 30 and 40 on to a Head

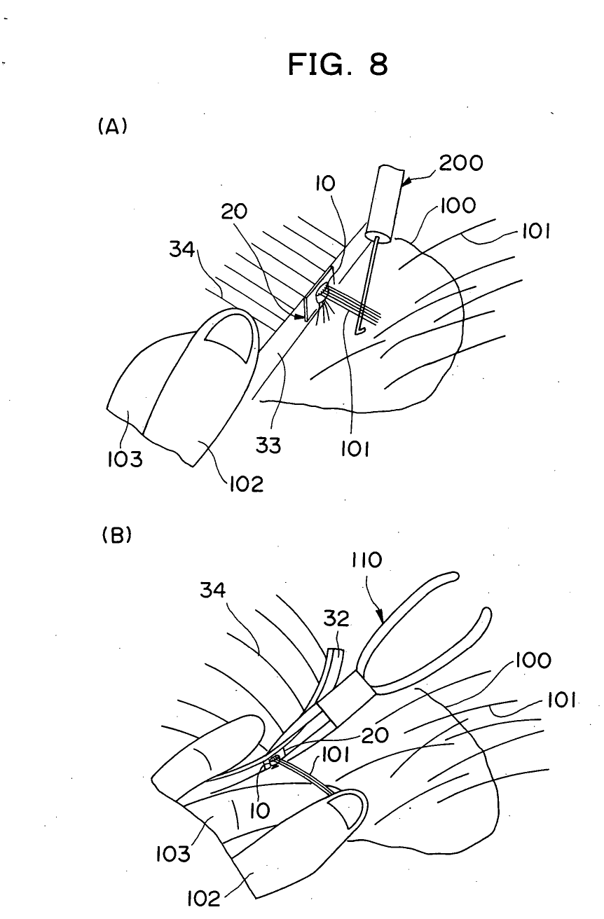

FIG. 8 is a schematic view illustrating a method of wearing a wig provided with a retaining device for hair ornament 30 of FIG. 4, and (A) is the step to insert a wearer's own natural hair into the retaining device for hair ornament 10, and (B) is the step to squash the retaining device for hair ornament 10.

The wig provided with the retaining device for hair ornament 30 is worn on to a head as described below.

First, the wig provided with a retaining device for hair ornament 30 is placed on to a head and its position is adjusted, and, as shown in FIG. 8(A), the peripheral frame member 33 of the wig 30 is rolled up by the handler's fingers 102 and 103. A hook needle 200 is inserted into the tube 11 of the retaining device for hair ornament 10, the tip of the hook needle 200 is hooked to the natural hair 101, and the hook needle 200 is pulled out of the tube 11. Thereby, the natural hair 101 can be inserted into the tube of the retaining device 10. Since the net 13 is provided on the inner surface of the retaining device 10, the natural hair 101 can be easily inserted. Also, since the adhesive layer 12c of the adhesive tape 12 provided outside of the net 13 does not directly adhere to the natural hair 101, the adhesive does not adhere to the handler's fingers attaching the retaining device for hair ornament 10, and hence insertion of the wearer's own natural hair can be easily conducted.

Next, as shown in FIG. 8(B), the handler moves the retaining device 10 toward the root end side of the wearer's own natural hair close to head skin, with the rolled up peripheral frame member 33 of the wig 30, aligns the natural hair 101 inserted into the tube 11 by pinching and smoothing with fingers 102 and 103, and presses the outer periphery of the tube 11 to properly squash with a squashing tool 110 such as pliers. Here, if the tube is squashed in the direction perpendicular to the natural hair 101 inserted into the retaining device 10, that is, perpendicular to the direction of length of the tube 11, then the natural hair 101 is pressed by proper resilience of the net 13 upon squashing of the retaining device 10, and is thereby frictionally bound with the net 13, and slippage is prevented. Further, since the adhesive layer 12c provided on the outer side of the net 13 is deformed upon pressing of the tube 11, and the adhesive permeates through the mesh of the net 13, the natural hair 101 mutually, and the natural hair and the net 13, adhere with the permeated adhesive. Therefore, the natural hair 101 is firmly held with the retaining device 10 by tightening by proper squashing and adhesion with the adhesive, and if drawing force is applied to the natural hair 101, it does not easily move or slip off. By the similar handling to each of a plurality of retaining devices 10 provided on the inner periphery of the wig 30, the body of the wig 31 can be firmly and stably worn on to the head 100.

As described above, by inserting a plurality of hairs 101, for example, 20-200 hairs into the tube 11, moving the retaining device 10 close to head skin, binding the retaining device 10 to hair by squashing the tube 11, thus insertion of hair into the tube 11, moving to head skin, and squashing are conducted in turn, and by fixing a plurality of retaining devices to hair, the body of a wig 31 is worn on to the head 100. By a simple handling to insert a wearer's own natural hair into each retaining device 10 provided on the periphery of the inner side of the wig 30, and to squash, the wig provided with a retaining device for hair ornament 30 can be attached to the head 100. In order to detach the wig provided with the retaining device for hair ornament 30 from the head 100, as mentioned before, the retaining device 10 can be easily taken off from the natural hair 101 by enlarging a hollow portion of the tube of the retaining device 10 and detaching.

Explanation is next made of comparative tests on effects of the retaining device of the present invention and that of prior arts.

In order to compare with the retaining device of the present invention provided with a net 13 and an adhesive 12 attached to the tube 11, a retaining device for hair ornament was manufactured which has urethane rubber instead of a net on the inner side of the tube, as the related art described in Reference 3 (the Japan laid open application H10-60721). When hair was inserted therein, and squashed with pliers, urethane rubber exuded from both ends of a tube resulting in unusable state.

Then, hair was inserted into said retaining device with urethane inner coat, which was squashed by the pressing force to the extent that urethane rubber did not exude from both ends of the tube, and tests were conducted of hair holding ability. The retaining device of the present invention was also manufactured and squashed by the pressing force of the same extent, and was tested for comparison similarly. As a result, hair was easily pulled out from the conventional retaining device by about 0.2-0.5 kgf/mm², while the retaining device of the present invention endured the load of about 0.8-2.3 kgf/mm², showing the superiority by far in hair holding ability compared with prior arts. This is because hair hooking ability of the net is higher than that of urethane rubber, and an adhesive of the adhesive tape permeates in the present invention to contribute the adhesion of the net and hair, and of hair and hair mutually.

(6) An Example of Structure of a Squashing Tool for a Retaining Device

Explanation is next made of a squashing tool suitable for squashing the retaining device for hair ornament of the present invention.

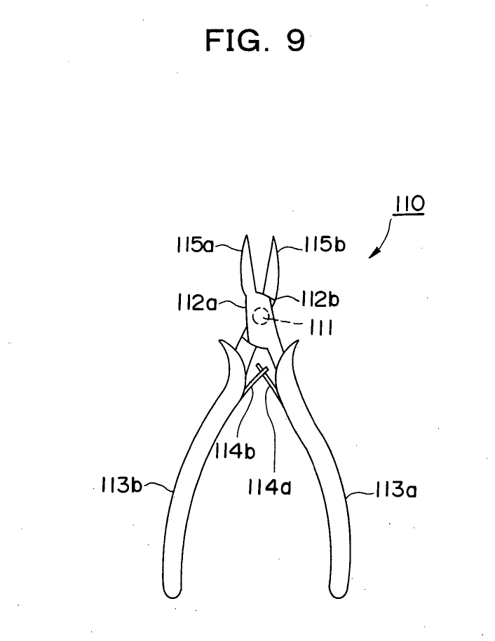

FIG. 9 is a schematic view illustrating a squashing tool 110 in accordance with the present invention, and as shown in FIG. 9, it comprises a pair of levers 112a and 112b axially supported mutually rotatably around an axial portion 111, grabbing portions 113a and 113b formed respectively at back end sides of a pair of levers 112a and 112b, and plate springs 114a and 114b to prevent rotation of a pair of levers 112a and 112b and to recover the original states. Namely, the squashing tool 110 comprises a pair of levers 112a and 112b connected with an axial portion 111 provided at the forward portion in its length direction, the grabbing portions 113a and 113b at the back end side of the pair of levers 112a and 112b rotate around the axial portion 111 so to approach one another, the pinching portions 115a and 115b at the tip end side of the pair of levers 112a and 112b rotate in reverse direction to one another, and the opposite pinching faces of the pinching portions 115a and 115b contact one another. At inner sides where the grabbing portions 113a and 113b face one another, plate springs 114a and 114b are provided, respectively, and when the plate springs 114a and 114b are compressed to one another upon the grabbing portions 113a and 113b being grabbed, the rotation of the grabbing portions 113a and 113b is recovered to the original position, and the pinching portions 115a and 115b come into non-contact state. In order to realize such non-contact state, a coil spring may do, not limited to the plate springs 114a and 114b as shown in the figure.

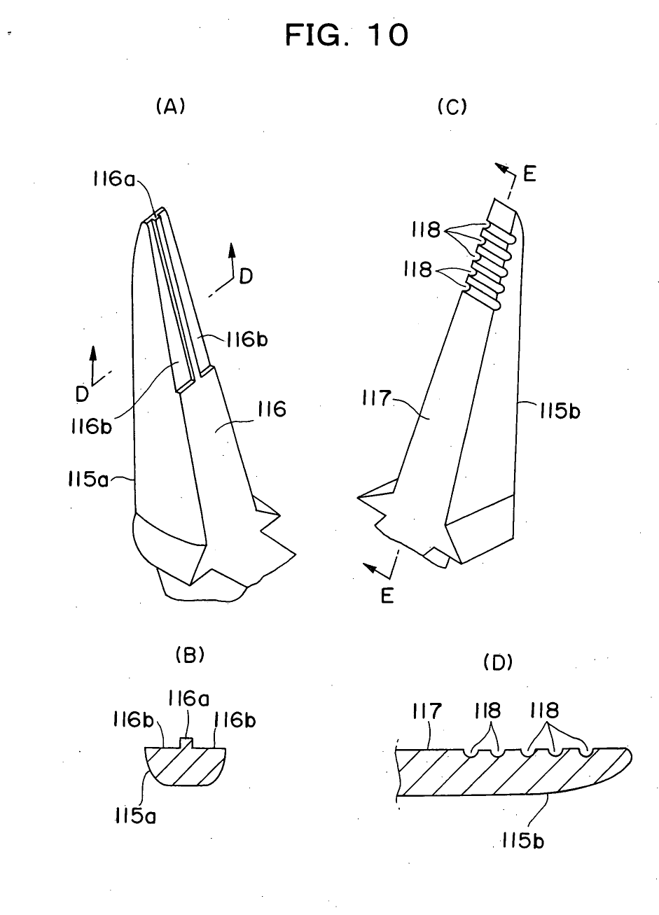

FIG. 10(A) is a diagonal view illustrating one of the pinching portions 115a of FIG. 9, (B) is a cross-sectional view along the line D-D, (C) is a diagonal view illustrating the other of the pinching portions 115b of FIG. 9, and (D) is a cross-sectional view along the line E-E. One of the pinching portions 115a of the squashing tool 110 is made up, as shown in FIG. 10(A), so that a convex portion 116a is formed in extension along the length direction of the pinching portion 115a on the pinching face 116 inside. Said convex portion 116a is formed in extension along the length direction of the lever 112a by forming cut faces 116b and 116b by cutting each tip end side in the left and right from the pinching face 116 of the pinching portion 115a. The convex portion 116a may be formed, as is necessary or desired, either in a line on the pinching face 116 of the pinching portion 115a, or in a plurality of lines. The width of the convex portion 116a may be designed arbitrarily, so far as narrower than the width of the pinching face 116. The convex portion 116a shown in FIG. 10 is formed at the center of the pinching face 116, but may be formed to the left or to the right.

The other pinching portion 115b facing the pinching portion 115a, as shown in FIG. 10(C) and (D), has one or more grooves 118 on its pinching face 117 inside about perpendicular to the length direction of the pinching portion 115b. Namely, one or more grooves 118 are formed at the tip end side of the pinching face 117 of the pinching portion 115b, so as to be perpendicular to the convex portion 116a formed in the other pinching portion 115a. When an object to be squashed is pinched with the pinching portion 115a and 115b, said groove 118 functions for antislipping so the retaining device for hair ornament to be squashed does not move.

As described above, the squashing tool 110 in accordance with the embodiment of the present invention is such that, in its pair of pinching portions 115a and 115b, the convex portion 116a is formed in extension to the length direction of a lever in one of the pinching portions 115a, while a groove 118 is formed in the direction perpendicular to the length of a lever in the other pinching portion 115b. When a tube 11 of a retaining device for hair ornament 10 is squashed with said squashing tool 110, the tube 11 with hair inserted therein is pinched with a pair of pinching portions 115a and 115b in the direction perpendicular to its length. The convex portion 116a formed in one of the pinching portions 115a is placed about at the central portion of the tube and squashed with the squashing tool 110, then about the central portion of the tube is squashed, a concave portion is formed deep on the outer periphery, and a gap between the tube and the inserted hair therein is narrowed. Thereby, tightening force of the tube to the inserted hair is strong, the retaining device retained on the hair does not easily slip off, and since both end portions of the tube are not strongly squashed, and said both end portions of the tube gradually opens from the central portion, hair close to both end portions of the tube is not easily cut.

Though not illustrated, the other pinching portion 115b may have a concave portion 116a similar to that provided to the pinching portion 115a, if necessary. In this case, if convex portions 116a are provided to the same opposite positions, a concave portion can be formed from both sides, even if the outer diameter of a retaining device for hair ornament to be squashed is large. Or if convex portions 116a are provided in the misaligned position in the pinching portions 115a and 115b, two lines of concave portions can be formed from both sides of the squashed object, and the squashing force can be increased corresponding to a special kind of object to be squashed.

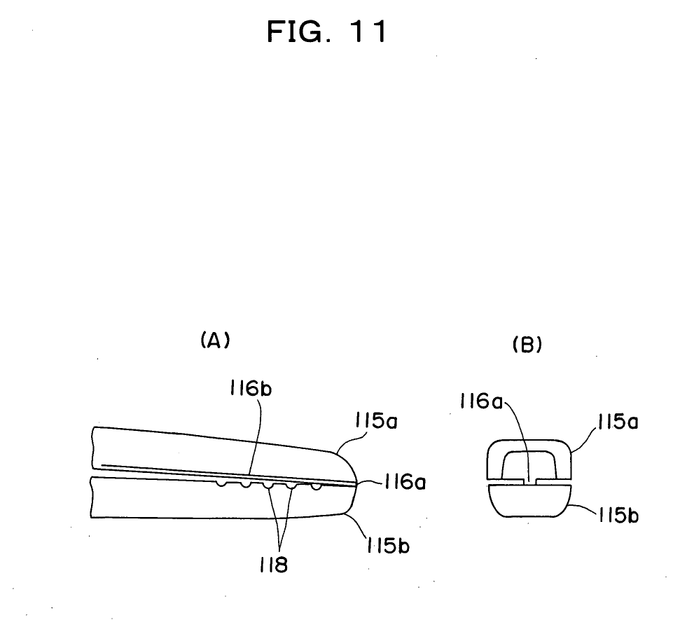

FIG. 11 is a view illustrating pinching portions 115a and 115b of the squashing tool 110 of the present invention in contacting state, and (A) is its side view, and (B) is a plan view illustrating the pinching portions 115a and 115b from their tip end sides. As shown in FIG. 11(A) and (B), a tip end portion of the convex portion 116a formed in one of the pinching portions 115a and the surface of a pinching face 116b of the other pinching portion 115b contact to one another, and can squash the object to be squashed formed as tubular like the retaining device for hair ornament 10. Here, “Squash” means in general to fix an object by applying pressure, but here in the present specification, it also includes the state where the object to be squashed is deformed by pinching with the squashing tool, and properly squashed or compressed. Pinching means tightening with pinching portions 115a and 115b, applying certain pressure.

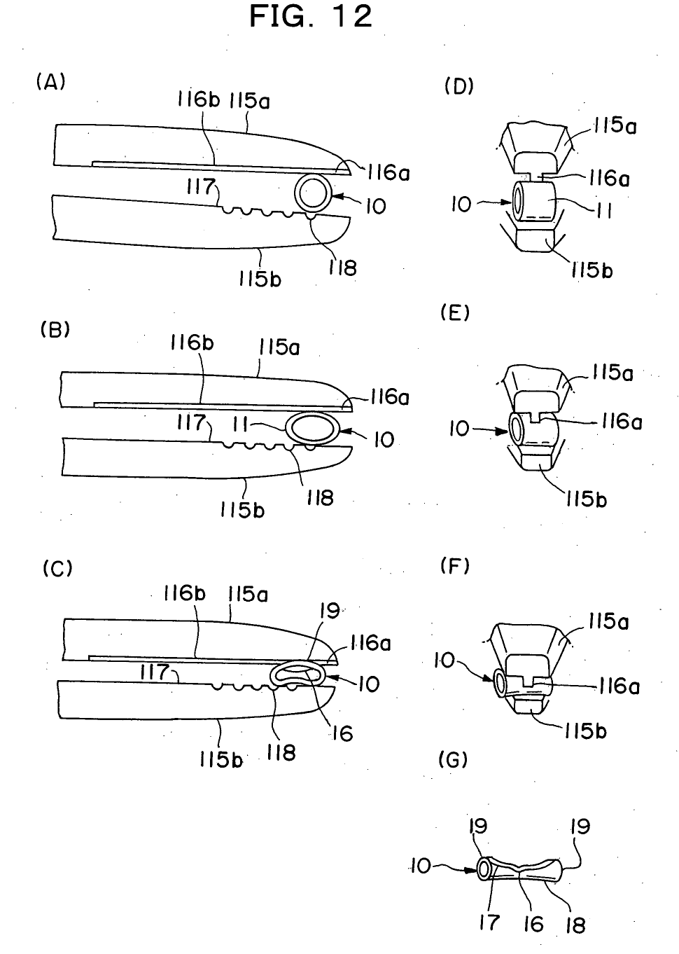

FIG. 12 is a schematic view illustrating the step to squash a retaining device for hair ornament 10 with the squashing tool 110, and (A)-(C) are side views, (D)-(F) are diagonal views from the tip end side of a circular retaining device for hair ornament 10, and (G) is a diagonal view of a retaining device for hair ornament 10 after squashed. As shown in FIG. 12(A) and (D), by pinching a retaining device for hair ornament 10 with tip end portions of pinching faces 116 and 117 of the pinching portions 115a and 115b, and, as shown in FIG. 12(B) and (E), by squashing the retaining device for hair ornament 10 with a convex portion 116a of the pinching portion 115a and a pinching face 117 of the pinching portion 115b, the tube 11 is gradually squashed and deformed to ellipsoid. With further pressure applied, as shown in FIG. 12(C) and (F), a convex portion 116a bites into the tube 11, resulting in formation of a concave portion 16 shown in FIG. 12(G), and a dent 17 smoothly connected to the concave portion 16 is formed, more or less shallower than the dent of the concave portion 16 with the span of both ends of the cut faces 116b and 116b at both sides of the convex portion 116a, that is, the width of a tip end portion of the pinching portion 115a. Here, on the pinching face 117 of the pinching portion 115b, namely, on the upper end side of the groove 118, the face opposite to the concave portion 16 and the dent 17 formed at the convex portion 116a and the tip end portion of the pinching portion 115a forms a dent 18 of the width of the tip end portion of the pinching portion 115b.

Therefore, pinching of the retaining device for hair ornament 10 with the squashing tool 110 does not cause both ends 19 of the retaining device for hair ornament 10 to be compressed for the convex portion 116a of the squashing tool 110 to bite in. That is, the retaining device for hair ornament 10 has a dent at the position where the convex portion 116a bites in, and its both ends 19 have open shapes, as if like a Japanese hand drum having a hyperbolic surface. Thus, since both ends 19 are less squashed than the central concave portion 16, in case to detach the squashed and fixed retaining device for hair ornament 10 with hair inserted therein, it is easy to insert a detaching tool such as forceps and a hook needle into the retaining device for hair ornament 10, and to enlarge quickly the inner periphery of the retaining device for hair ornament 10. Therefore, detaching of said retaining device for hair ornament 10 can be performed easily and quickly.

Further explanation is made of the case to attach a retaining device for hair ornament 10 with artificial hair 15 to hair 101 with an example, referring to FIG. 2 again.

As shown in FIG. 2, a part of the wearer's own natural hair 101 grown on a head 100 is inserted into a tube 11 of a retaining device for hair ornament 10, said retaining device for hair ornament 10 is moved as close as possible to the root of hair, and the outer periphery 11a of the tube 11 is squashed with the squashing tool 110. Here, the outer surface 11a of the tube 11 is pinched and squashed with the pinching portions 115a and 115b of the squashing tool 110 so as for the extended direction of a convex portion 116a provided to the pinching portion 115a of a squashing tool 110 to cross, preferably orthogonally, the length direction of the tube 11. Thereby, a linear or narrow band-like concave portion 16 and a dent 17 are formed so as to orthogonally cross the length direction of the retaining device for hair ornament 10, and thereby, without formation of a gap between the inserted the natural hair 101 and the inner surface of the retaining device for hair ornament 10, the natural hair 101 can be tightened with the retaining device for hair ornament 10. Even with a quite small retaining device for hair ornament with diameter of 3 mm, and length about 3-5 mm, by properly designing the width and height of the convex portion 116a formed on the pinching face 116 of a squashing tool 110, the retaining device for hair ornament 10 is partially squashed easily, and a concave portion 16 and a dent 17 shown in FIG. 12 can be formed in a part of a retaining device for hair ornament 10.

With commercial pliers, if a retaining device for hair ornament is made to be as quite short as about 3-5 mm, whole length of the tube would be squashed. Therefore, the squashing pressure is dispersed to make whole tube flattened, and the concave portion on the outer periphery of a tube formed by a groove of a pinching portion of the tip end portion of the pliers is made shallow, and a gap between the inner side of the tube and the hair inserted therein is enlarged. Therefore, tightening of the inserted hair is weak, the retaining device for hair ornament tends to slip off easily from hair, and the hair close to both ends of the squashed tube tends to be cut off. On the contrary, with a squashing tool of the present invention to squash a retaining device for hair ornament, to squash the retaining device for hair ornament 10, the squashing pressure is locally applied to a convex portion 116a by squashing a part of an outer periphery 11a of the tube 11 with hair 101 inserted therein, for example, a central portion with the convex portion 116a of the squashing tool, and further with a convex portion 116a along the length direction formed in one of the pinching portions 115a, and with a groove 118 formed in the other 115b in the orthogonal direction to said convex portion, the concave portion 16 formed on the periphery of the tube is deepened, the gap between the inside of the tube and the hair inserted therein is made small, and the tightening force of the inserted hair is strong. Therefore, the retaining device retained on hair does not easily slip off from hair 101.

Both ends of the retaining device for hair ornament 10 are not squashed, as shown in FIG. 12(G), so much as the distance by which the convex portion 116a of the squashing tool 110 bites in. That is, the retaining device for hair ornament 10 has a dent at the position where the convex portion 116a bites in, and its both ends have open shapes, as if like a Japanese hand drum. Thus, such detaching tools as forceps and a hook needle can easily be inserted from both ends of the retaining device for hair ornament 10 which can be detached by enlarging the inner side of the retaining device for hair ornament 10.

As described above, in case not only to use a retaining device for hair ornament 10 with artificial hair 15 attached to the natural hair 101, but also to wear a hair ornament such as an accessory having various decorations like added hair of so-called extension, animals, plants, and character goods to a wearer's own natural hair, and to fix a wig by attaching the retaining device for hair ornament 10 inside the wig, and inserting hair into said retaining device, the retaining device for hair ornament 10 can be squashed using a squashing tool of the present invention. In this case, since the natural hair 101 is tightened with the retaining device for hair ornament 10, the natural hair 101 can be so made not to easily slip off from the retaining device for hair ornament 10. That is, by using a squashing tool 110 of the present invention, only a part of a tube 11 of the retaining device for hair ornament 10, for example, only a central portion, can be squashed by pre-set pressure, and since said central portion of the tube 11 is shrunk like a Japanese hand drum, as well as both or one end is not squashed, or opened like a funnel compared to the squashed portion, the retaining device for hair ornament can easily be detached from hair by inserting forceps or a hook needle into said opened portion, and operability is improved.

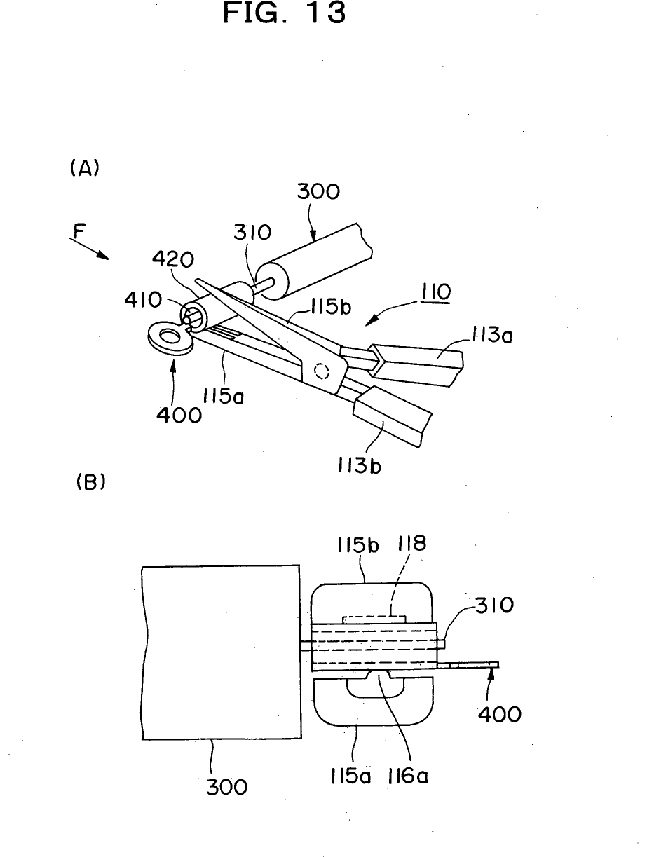

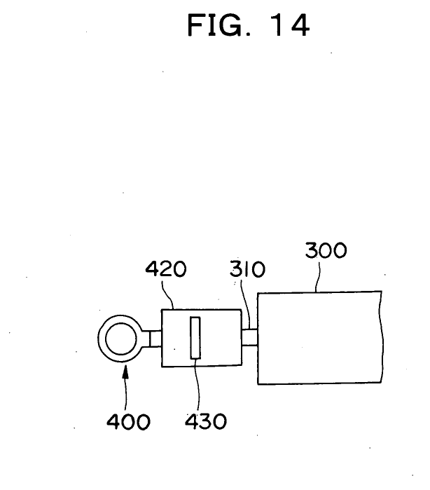

The squashing tool 110 of the present invention can be used, not only to retain the retaining device for hair ornament 10 to hair, but also to squash efficiently other objects to be retained. FIG. 13(A) is a diagonal view illustrating an example of another embodiment of a squashing tool 110, and (B) is a view from the arrow mark F of (A). In FIG. 13, an example is shown for attaching a squashed terminal 400 to conduction wire 310. As shown in FIG. 13, the cover at a tip end portion of covered conduction wire 300 is peeled off, said portion is inserted into a hollow portion 410 of the squashed terminal 400, and the outer surface of a tube 420 constituting the hollow portion 410 is squashed with the squashing tool 110. Here, the tubular portion 420 is pinched with pinching portions 115a and 115b of the squashing tool 110 by rotating grabbing portions 113a and 113b around the axis 111, so that the extended direction of a convex portion 116a of the squashing tool 110 crosses, preferably orthogonally, the length direction of the tube 420, namely, the direction of conduction wire 310. FIG. 14 is a plan view illustrating a squashed terminal 400 after the tubular portion 420 of a squashed terminal 400 is squashed with a squashing tool 110. As shown, a concave portion 430 is formed on the outer surface of the tubular portion 420 of a squashed terminal 400 to orthogonally cross the length direction. Thereby, since the concave portion 430 is formed with narrow width, the outer surface of conduction wire 310 contacts a part of the inner wall of the squashed terminal 400, and a part of conduction wire 310 is bent in some cases, so the conduction wire 310 can be made not to easily slip off from the squashed terminal 400.

What is claimed is:

1. A method of wearing a wig, comprising the steps of;
fixing a plurality of retaining devices for hair ornament on the periphery of the body of the wig at proper intervals, wherein the retaining device for hair ornament has a squashable tube into which a plurality of hairs are to be inserted, and a net attached on the inner surface of said tube via an adhesive,
inserting a plurality of hairs into said tube with said body of the wig placed on a wearer's head,
moving said retaining device for hair ornament close to the head skin,
tightening the retaining device for hair ornament to the hair by squashing said tube, and
adhering said hair to the net with the adhesive permeated out through the mesh of the net,
wherein insertion of hair into said tube, moving the retaining device for hair ornament close to the head skin, and squashing are carried out in turn, thereby the wig is worn on to the head by fixing a plurality of retaining devices for hair ornament to the hair.

2. A retaining device for hair ornament, comprising a tube into which a plurality of hairs are to be inserted, and a net attached on the inner surface of said tube.

3. A retaining device for hair ornament as set forth in claim 2, wherein said tube is made of a squashable metallic short tube.

4. A retaining device for hair ornament as set forth in claim 2, wherein said net is attached by adhesion to the inner surface of said tube via an adhesive.

5. A retaining device for hair ornament as set forth in claim 4, wherein said adhesive is made of a double-stick adhesive tape having adhesive layers on both sides.

6. A retaining device for hair ornament as set forth in either of claims 2-4, wherein said tube is designed as having a radial thickness of 0.2-0.3 mm, and a length of 2.5-3.5 mm.

7. A retaining device for hair ornament, comprising;
a body of the retaining device including a squashable tube into which a plurality of hairs are to be inserted, and a net attached on the inner surface of said tube, and
a fixing member for fixing said body of the retaining device to the inner surface of a wig,
wherein the wig is held on to a head with said hair and the body of the retaining device for hair ornament by squashing said tube with a plurality of hairs inserted therein.

8. A retaining device for hair ornament as set forth in claim 7,
wherein said fixing member comprises a base portion for fixing said body of the retaining device, an adhesive layer on the surface of said base portion, and a string for fixing said body of the retaining device on to the back side of said base portion,
and said adhesive layer of the surface of said base portion is fixed by adhesion on to the inner surface of a wig.

9. A retaining device for hair ornament as set forth in claim 8,
wherein said base portion of the fixing member is made of an adhesive tape having an adhesive layer coated on the surface of a core member, thereby said body of the retaining device is fixed on to the core member of the back side of said base portion.

10. A retaining device for hair ornament as set forth in claim 8,
wherein said base portion of the fixing member is made of a double-stick adhesive tape having two adhesive layers coated on the front and the back sides of a core member, and
wherein said body of the retaining device is adhered to the adhesive layer on the back side of said base portion.

11. A retaining device for hair ornament as set forth in claim 8,
wherein said string is inserted into the tube of said body of the retaining device, and its both ends are inserted into said base portion and bound, thereby fixing said body of the retaining device to said base portion.

12. A wig provided with retaining devices for hair ornament, comprising
a body of the wig, and a plurality of retaining devices for hair ornament fixed on the periphery of the inner surface of said body of the wig,
wherein said retaining device for hair ornament includes a squashable tube into which a plurality of hairs are to be inserted, a net attached on the inner surface of said tube, and an adhesive tape provided between said net and the inner wall of the tube to adhere the net to the tube.

13. A wig provided with retaining devices for hair ornament as set forth in claim 12,
wherein said retaining device for hair ornament is fixed to the inner periphery of said body of the wig so that the axis of said tube is aligned perpendicular to the periphery of said body of the wig.

14. A squashing tool, having
a pair of levers axially supported rotatably around an axial portion, and
two pinching portions formed to tip end sides from the axial portion of said levers for squashing a retaining device for hair ornament,
wherein a convex portion is formed along the length direction in the pinching portion formed in at least one of the levers, and
a linear or a narrow band-like concave portion corresponding to said convex portion is formed on said retaining device for hair ornament by pinching the retaining device for hair ornament with said two pinching portions.

15. A squashing tool as set forth in claim 14,
wherein one or more of grooves for antislippage are formed in the pinching portion formed in one of the levers among said pair in a crossing direction to said convex portion.

16. A squashing tool as set forth in claim 14, wherein said convex portion is formed along the length direction of each lever at a pair of pinching portions of said levers.

17. A squashing tool as set forth in claim 14 or claim 16,
wherein said convex portion is formed along the length direction and at an identical position of each lever at a pair of pinching portions of said levers.

18. A squashing tool as set forth in claim 14 or claim 16,
wherein said convex portion is formed along the length direction and at a different position of each lever at a pair of pinching portions of said levers.

19. A squashing tool as set forth in either of claim 14 or claim 16, wherein
one or more of said convex portions are formed.

20. A squashing tool as set forth in claim 17, wherein one or more of said convex portions are formed.

21. A squashing tool as set forth in claim 18, wherein one or more of said convex portions are formed.
